(19) United States
(12) Patent Application Publication
(10) Pub. No.: US 2011/0183044 A1
(43) Pub. Date: Jul. 28, 2011

(54) FOLDED, EMBOSSED FOOD PRODUCT AND APPARATUS FOR AND METHODS OF PREPARATION

(76) Inventors: Craig E. Zimmermann, Waconia, MN (US); Richard O. Benham, New Hope, MN (US); Philippea Vandewghe, Plymouth, MN (US); Thomas Luehrs, Rogers, MN (US)

(21) Appl. No.: 12/522,194

(22) PCT Filed: Dec. 12, 2007
(86) PCT No.: PCT/US07/87116

§ 371 Date: Mar. 23, 2011

Related U.S. Application Data
(60) Provisional application No. 60/883,917, filed on Jan. 8, 2007.

(51) Int. Cl. A23G 3/02; A23B 4/10

(52) U.S. Cl. 426/90; 426/517; 99/450.1

(57) ABSTRACT

A food item is prepared by depositing food (14) as lanes in the form of rows of discrete patterns (14a) on strips (16a-16c) of support material (16) defined by fold lines defined by perforations (62a, 62b). In a strip sheeter (12), the first roller (18) is heated and is smooth for abutting with the support material (16). The outer periphery of the second roller (20) including depressions (24) forming the patterns (14a) is formed of material to which food (14) has less tendency to stick to than the support material (16), with the patterns (14a) arranged to create tensional removal. An edible, liquid release agent can be sprayed upon the second roller (20). Perforations (62a, 62b) are cut by rotary knives (62). The first strip (16a) is folded to overlie the first lane of food (14) on the second strip (16b), and the third strip (16c) is folded to abut the second lane of food (14) thereon and opposite to the second strip (16b).

### BACKGROUND OF THE INVENTION

The present invention relates to food products and to their apparatus for and methods of preparation. More particularly, the present invention relates to intermediate moisture food products such as dried fruit pastes or fruit flavored confections and to their apparatus for and methods of preparation. Specifically, the present invention relates to discretely patterned food products on a folded support surface and to their apparatus for and methods of preparation.

Wholesome snacks prepared from sweetened intermediate moisture shelf stable fruit or “fruit snacks” herein have expanded their popularity as food items. These dried fruit products are especially popular with children, particularly as snack or convenience foods. Their popularity has created a highly competitive marketplace. To appeal to children, the primary consumer of fruit snacks, manufacturers must introduce frequent changes to these products. New shapes, colors, textures and flavors are all avenues employed to successfully market these products. To create unique fruit snack shapes, some manufacturers have changed their products to resemble popular characters from movies, television shows, cartoons, etc. To fully appreciate the need for new fruit snack shapes, it is important to understand the wide variety of fruit snacks currently available.

Broadly, fruit snacks are prepared from wet mixtures of the various fruit materials, added ingredients and extra water that are cooked and worked at elevated temperatures and then dried to desired moisture contents to form hot plastic paste or fluid formable fruit masses. The formable fruit masses are then formed into articles of desired shapes and sizes.

Fruit snack compositions are sold in various physical forms and shapes such as: 1) in rolled sheet form; 2) in rolled strip form; 3) in string form mounted on a U-board; 4) soft center filled pieces, and 5) in gelled bite size pieces of various shapes or in gelled bite size piece forms prepared by starch molding. The products are typically packaged in a moisture impermeable container such as a flexible laminated film pouch fabricated to include a moisture barrier layer.

A particularly popular fruit snack available in rolled sheet form is sold under the FRUIT ROLL-UPS brand. Popular products in rolled strip form are sold under the FRUIT BY THE FOOT brand (See for example, commonly assigned U.S. Pat. No. 5,455,053 entitled “Rolled Food Item” issued Oct. 3, 1995). Food products in string form mounted on a U-board were sold under the STRING THING® mark (See for example, commonly assigned U.S. Pat. No. 5,846,588 entitled “Food Item Fabricating Apparatus and Methods” issued Dec. 8, 1998). While other products in bite size pieces of various shapes are sold under various brands. (See, for example, commonly assigned U.S. Pat. No. 5,942,268 entitled “Embossed Shape Food Item” issued Aug. 24, 1999 to Zimmermann et al.). Soft center filled pieces products are described in U.S. Pat. No. 4,853,236 entitled “Dual Textured Food Piece Of Enhanced Stability Using An Oil In Water EMULSION” (issued Mar. 18, 1988 to Langler et al.) while apparatus and fabrication methods therefor are described in U.S. Pat. No. 5,208,059 entitled “Dual Textured Food Piece Fabrication Apparatus” (issued Jun. 10, 1992 to Dubowik et al.).

In other variations, all or a portion of the fruit material is substituted with pure sugars to provide confections. Such low fruit, high sugar formulations can be flavored with fruit flavors and/or other flavors. Within this general similarity, however, the particular methods of preparation, product formulations and apparatus used to prepare particular products vary considerably. Moreover, such variations are highly interdependent. Formulations and method steps suitable for one product form might or might not be suitable for another product form. Also, such products can be fortified with vitamins and minerals, especially calcium for growing children.

The variety of fruit snack shapes including applying character attributes introduce an element of fun or fantasy to the eating experience described as play value. Play value as it relates to fruit snacks is the ability to manipulate a product in a fun or amusing manner. In its more imaginative form, play value entails shaping or coloring a product to represent an unusual object that relies upon the child to discover a use or method to disassemble the product before consumption. The more discoveries built into a fruit snack, the greater the amusement and appreciation by children. The interaction of two or more food pieces is especially amusing when disassembly can easily be achieved and it yields an unexpected result.

The present invention is directed toward those articles and improvements in the apparatus for and methods of preparation of the hot plastic paste or fluid formable masses such as fruit pastes and their formation into various suitable shaped and sized pieces. In view of the current state of the intermediate moisture food art, there is a continuing need for new and improved formulations and methods for preparing intermediate moisture shaped food products. As an example, in the current invention, the food product is formed into independent patterns by passing between forming rollers with a support material sheet, which support material sheet is folded between rows of patterns before cutting to length and packaging. Thus, the play valve of the product according to the present invention is enhanced due to the variety of patterns possible and the novel disassembly required for consumption.

### BRIEF SUMMARY OF THE INVENTION

The present invention solves these problems and needs in the field of food products and in most preferred forms of dried fruit pastes and fruit flavored confections, by providing, in preferred aspects, a food item including a first strip of support material folded along a first fold line and abutting with a first lane of food deposited on a second strip of support material and including a third strip of support material folded along a second fold line parallel to the first fold line such that food deposited upon the third strip of support material abuts with the folded first strip of support material with the first strip of support material located intermediate the first and second lanes of food, and the methods of and apparatus for preparation thereof. In preferred aspects, the fold lines are formed by altering the support material such as by perforating the support material in the most preferred form.

In further aspects of the present invention, the lanes of food are each at least one row of individual patterns formed by passing the support material and food through the abutment nip of first and second counter-rotating rollers. To enhance the separation of the food patterns from depressions formed in the second roller, the present invention provides several enhancements. Specifically, the first roller against which the support material abuts is smooth and heated, whereas the second roller is not heated and possibly even cooled. Likewise, the outer periphery and depressions of the second roller are formed of material to which food has less tendency to stick than the support material such as being formed in Ultra High Molecular Weight (UHMW) polyethylene or being coated with a TEFLON® nonstick coating. Additionally, an edible, liquid release agent can be added to the second roller before the abutment nip such as by spraying. Also, although in one form the individual patterns are discrete and separable from the support material individually when cold, the depressions in the second roller and the patterns include complete annular boundaries but which touch for creating tensional removal from the depressions of the second roller while hot during fabrication. In alternate forms, the depressions in the second roller and the patterns include interconnections for creating tensional removal from the depressions of the second roller while hot during fabrication.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic side view of an apparatus for fabricating a folded food item according to the preferred teachings of the present invention.

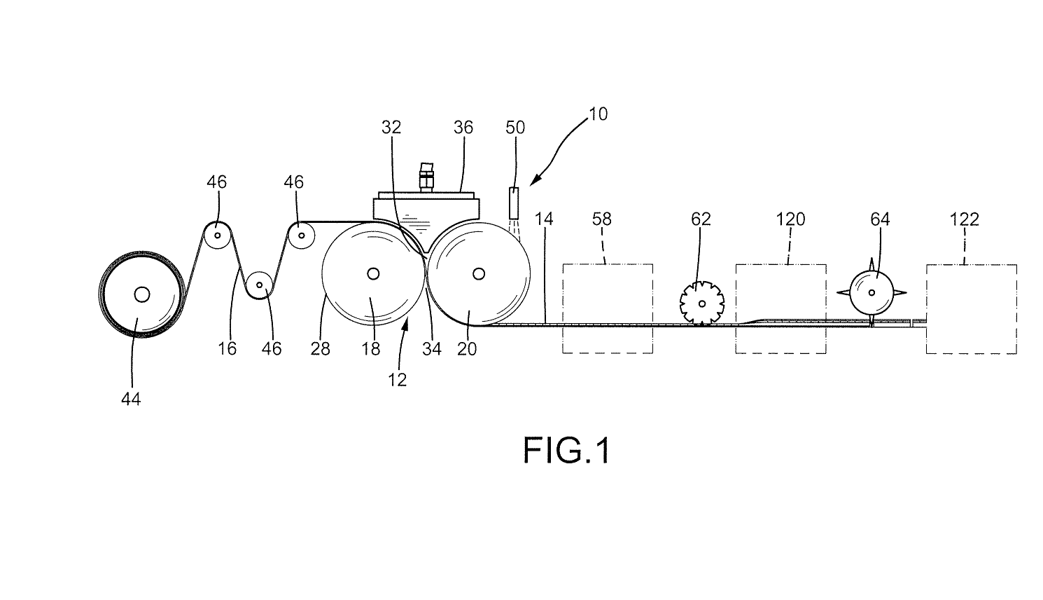

FIG. 2 shows a perspective view of a second roller of the strip sheeter of the apparatus of FIG. 1.

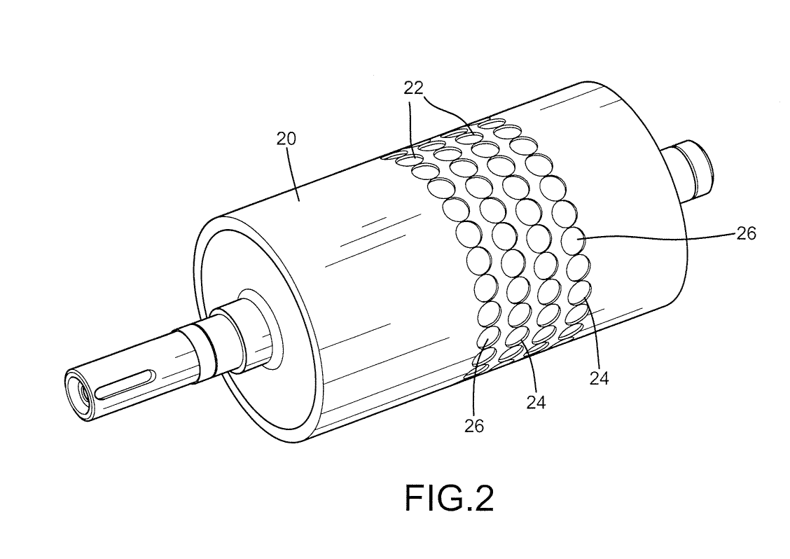

FIG. 3 shows a partial, top view of the rows of patterned food deposited on a sheet of support material by the strip sheeter of the apparatus of FIG. 1 utilizing the second roller of FIG. 2.

FIG. 4 shows a partial, top view of the food fabrication shown in FIG. 3 after folding of the sheet of support material.

FIG. 5 shows a perspective view of the folded food item.

FIG. 6 shows a perspective view of the folded food item, with portions rolled back for illustrative purposes.

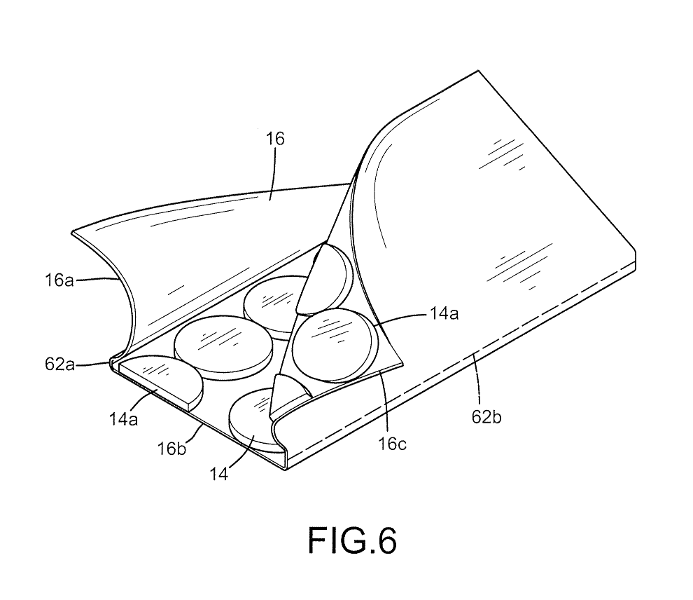

FIG. 7 shows a perspective view of an alternate embodiment of a second roller of the strip sheeter of the apparatus of FIG. 1.

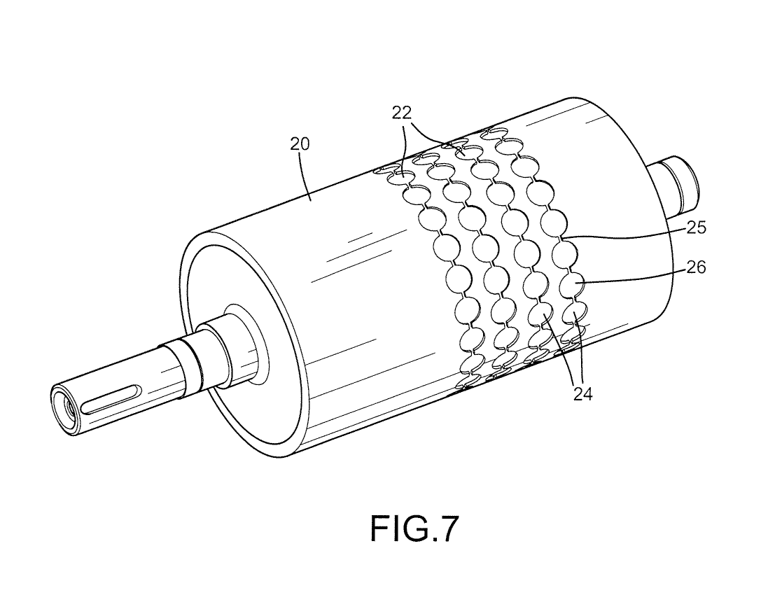

FIG. 8 shows a partial, top view of the rows of patterned food deposited on a sheet of support material by the strip sheeter of the apparatus of FIG. 1 utilizing the second roller of FIG. 7.

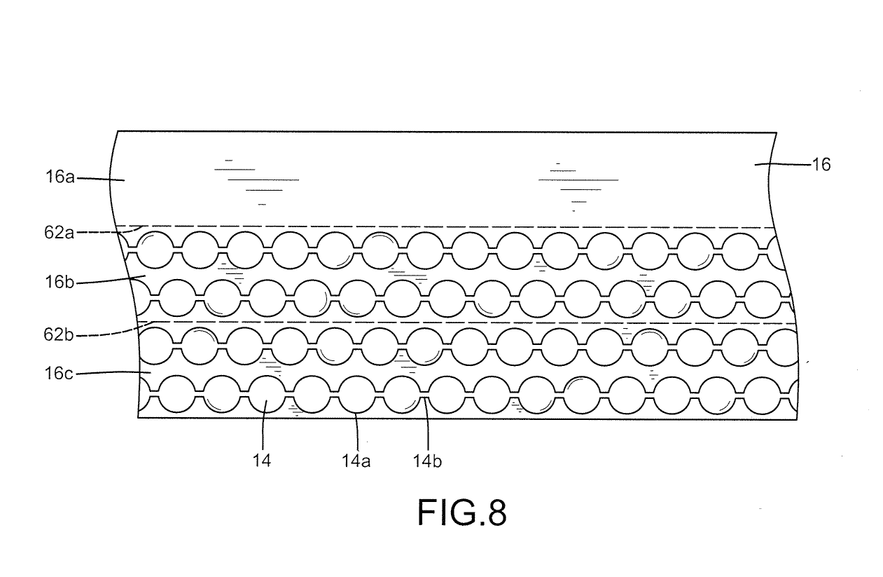

All figures are drawn for ease of explanation of the basic teachings of the present invention only; the extensions of the Figure with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “end”, “axial”, “longitudinal”, “width”, “height”, and similar terms are used herein, it should be understood that these terms have reference only to the structure shown in the drawings as it would appear to a person viewing the drawings and are utilized only to facilitate describing the invention.

### DESCRIPTION OF THE PREFERRED EMBODIMENTS

An apparatus utilizing the present methods for fabricating a food item, especially a dehydrated fruit puree, on a continuous strip of support material, with the food and support material being folded to produce the food item, according to the preferred teachings of the present invention is shown in the drawings and generally designated 10. Apparatus 10 includes a strip sheeter 12 for forming a plurality of spaced, parallel, rows of individual patterns 14a of food 14 of a thinness requiring external support upon a continuous web or sheet of support material 16. In the most preferred form, food 14 is a sweetened dehydrated fruit-based material typically referred to in the art as a fruit leather which can be derived from fruit purees and in the most preferred form is of the same type as utilized in the first, solid or “hard” portion or region of the dual textured food piece described in U.S. Pat. No. 4,847,098 issued Jul. 11, 1989 to J. E. Langler and in U.S. Pat. No. 4,853,236 issued Aug. 1, 1989 to J. E. Langler, each entitled Dual Textured Food Piece of Enhanced Stability and each of which is hereby incorporated herein by reference. Support material 16 may be formed of any suitable material such as silicon parchment paper which has the necessary strength to support food 14 without tearing and without bulkiness to allow folding of food 14 and support material 16 into a compact food piece and which allows food 14 to be easily separated therefrom for consumption.

Strip sheeter 12 generally includes first and second press rollers 18 and 20. Roller 18 is formed of steel and includes a cylindrical periphery 28 which is relatively smooth. In the preferred form, roller 18 is heated by any suitable means, not shown, such as by hot water and/or steam, to a temperature at cylindrical periphery 28 in the preferred form in the range of 160° F. (70° C.) to 200° F. (95° C.) and in the most preferred form in the order of 180° F. (82° C.). The periphery of roller 20 is embossed and specifically includes a plurality of spaced, parallel, rows 22 each formed from a plurality of depressions 24 around the periphery of roller 20. The spacing between rows 22 is generally equal to the desired spacing between the rows of food 14 which in the preferred form is in the order of three-eighths inch (one centimeter). In the preferred form shown, the bottoms 26 of depressions 24 extend along a cylinder in configuration and are relatively smooth.

Rollers 18 and 20 are rotatably mounted in an abutting relation, with periphery 28 of roller 18 engaging and rolling upon the outer periphery of roller 20 around depressions 24 along an abutment nip. In the most preferred form, rollers 18 and 20 are generally cylindrical and of equal diameters. Rollers 18 and 20 are rotated in opposite rotational directions in the preferred form shown at comparable rotational speeds to define an upper, mating side 32 and a lower, exit side 34. To allow cleaning, roller 20 can be slideably mounted relative to roller 18 to allow separation of roller 20 from roller 18.

The peripheries of depressions 24 perpendicular to the outer periphery of roller 20 can have any desired shape and, for purposes of illustration, are generally cylindrical in shape having constant circular cross sections. Further, in the form shown, depressions 24 are shown to be of a same size in each row 22 and in all of rows 22. The bottoms 26 of depressions 24 extending within the peripheries are relatively smooth and parallel to the outer periphery of roller 20 in the form shown. However, it can be appreciated that depressions 24 can have other shapes such as in the shape of vehicles like planes, cars, trucks, or the like, letters, numbers, characters such as cartoon figures, logos, or any desired shape. Likewise, bottoms 26 of depressions 24 can be sculpted such that the surface of food 14 opposite to support material 16 is not parallel to the surface of food 14 abutting with support material 16 such as but not including letters and numbers to create a coin, or the like. Further in the most preferred form, depressions 24 are staggered along axial lines around the outer periphery to help reduce the possibility of rollers 18 and 20 bouncing due to their outer peripheries rolling upon each other.

Food 14 heated to a temperature to become flowable or pumpable is pumped into upper mating side 32, with a containment saddle 36 being provided complementary to and for holding food 14 above and evenly feeding material to and within mating side 32. In the preferred form, saddle 36 includes passages, not shown, receiving pumped food 14 and having outlets in upper mating side 32 at locations corresponding to rows 22 of roller 20. It should be appreciated that each of the passages corresponding to rows 22 of the most preferred form can receive food 14 having different colors, flavors or other distinctions than the other passages, if desired.

Support material 16 typically is supplied from a roll 44 and, after extending around the customary tension rollers 46, is fed to extend under saddle 36 engaging roller 18 and to extend between the nip of rollers 18 and 20 into exit side 34. Food 14 is initially located in mating side 32 intermediate support material 16 and second roller 20. In exit side 34, support material 16 is pulled typically by vacuum conveyors downstream from strip sheeter 12 to extend under the periphery of roller 20 within exit side 34 and then extend with a small amount of tension generally tangentially therefrom in a longitudinal direction.

It can then be appreciated that as food 14 and support material 16 is pulled between the abutment nip between rollers 18 and 20 by the rotation of rollers 18 and 20, food 14 and support material 16 advancing between rollers 18 and 20 will be compressed into depressions 24 such that food 14 will be deposited in spaced, parallel, rows of individual patterns 14a of food 14 upon support material 16, with the number, width and height of patterns 14a of food 14 corresponding to the number, width and depth of depressions 24 and the spacing between the rows of patterns 14a of food 14 corresponding to the spacing between rows 22.

It can be appreciated that support material 16 separates food 14 from roller 18 and should prevent food 14 from adhering thereto. However, if a problem should arise, such as food which could flow around the ends of support material 16 or through breaks or tears in support material 16, a suitable scraper can be provided for roller 18.

It should be appreciated that food 14 must separate from roller 20 and/or must adhere to support material 16. In a lesser preferred embodiment, a sacrificial film material such as taught in U.S. Pat. No. 5,846,588 can be placed upon roller 20 before its introduction into saddle 36. However, such sacrificial films (or bending the support material as in U.S. Pat. No. 5,205,106) limit the ability to create sharp and well defined walls and corners in food 14 deposited upon support material 16. Thus, in the most preferred form, food 14 is compressed into depressions 24 of rollers 20 without an intermediate and continuous layer of material, which was not previously accomplished by the prior art. This operation which was not contemplated prior to the present invention is the synergistic result of one or more design characteristics. Specifically, the smooth periphery on rollers 18 and 20 is reversed from that shown in U.S. Pat. No. 5,205,106 to roller 18 which supports support material 16. Additionally, roller 18 is heated in the present invention rather than roller 20 of U.S. Pat. No. 5,205,106. It should be appreciated that food 14 gels or sets with lower temperatures, and as food 14 gels or sets, it has reduced tackiness. Thus, as roller 18 is heated, food 14 adjacent to support material 16 (which is heated by roller 18) will tend to be warmer than food adjacent to roller 20 and thus food 14 will have a greater tendency to stick to support material 16 than roller 20 and thus will have a greater tendency to stay upon support material 16 than roller 20 as it passes into lower, exit side 34. This tendency can be enhanced by operator involvement in adjusting heating of roller 18 and/or of adjusting cooling of roller 20, if available. In a preferred form, roller 20 has a considerably larger diameter than roller 18 to increase residence time of food 14 in depressions 24 to allow food 14 adjacent to the surfaces of depressions 24 to gel and otherwise set up such that it will have a greater tendency to stick to support material 16. It can be appreciated that the combination of a larger diameter roller 20 and chilling roller 20 (while heating roller 18) could produce synergistic results.

Further, selection of material from which roller 20 is formed can reduce the tendency of food 14 to stick thereto so that it has a greater tendency to stick to support material 16. Coating roller 20 with TEFLON® nonstick coating has been found to be a satisfactory manner to reduce the tendency of food 14 to stick to support material 16. Furthermore, forming the periphery of roller 20 including depressions 24 in a sleeve received on a mandrel and formed of ultra high molecular weight polyethylene has also been found to be a satisfactory manner to reduce the tendency of food 14 to stick to support material 16. However, the selection of other coatings for and/or other materials to form roller 20 according to the teachings of the present invention may be possible to those skilled in the art.

Furthermore, an edible, liquid release agent could be added as a layer to roller 20 before food 14 is allowed to enter depressions 24. In a preferred form, one or more nozzles 50 such as fan nozzles spray a suitable release agent in the form of a solution which could be misted upon roller 20 generally before entering saddle 36. Suitable edible, liquid release agents include mineral oils (which may be undesirable as leaving an oily residue which can affect the taste and handling attributes of food 14), other edible oils or fats, emulsifiers, water in the form of steam or liquid, combination thereof, or similar release agents which are edible and need not be removed after fabrication and which does not adversely affect the appearance or taste of food 14. The amount of release agent is modest (e.g. in a weight ratio of release agent to food ranging from about 1:50 to about 1:200, preferably about 1:100)

Furthermore, in one preferred form, touching of the annular boundaries of depressions 24 in rows 22 results in food 14 being pulled from roller 20 by food 14 on support material 16 downstream of roller 20. In this regard, a most preferred form of the present invention, it is desired that patterns 14a be separate and distinct from each other such that patterns 14a separate from each other at room temperature when removed from support material 16 when consumed. However, touching of patterns 14a, especially adjacent to support material 16, assists in interconnecting patterns 14a for purposes of creating tensional removal from depressions 24 and roller 20. In this regard, it was discovered that heating of roller 18 minimizes flash or the tendency of food 14 to form a skin on support material 16 outside of depressions 24.

Similarly and in alternate preferred forms of the present invention, the annular boundaries of depressions 24 in rows 22 do not touch but interconnections 25 extend between depressions 24 which in turn result in the formation of interconnections 14b between patterns 14a. In this regard, in this preferred form of the present invention shown, patterns 14a can be pulled from support material 16 in a serial manner in the direction of interconnections 14b when consumed so that it is not necessary to individually remove each pattern 14a. Furthermore, interconnections 14b create tensional removal of patterns 14a from depressions 24. In addition to advantageous removal of food 14, other advantages in the formation and operation of apparatus 10 are also obtained. Specifically, allowing flow of food 14 between depressions 24 through interconnections 25 in turn allows introduction of food 14 into saddle 36 at lower operating pressure while reducing any tendency of food 14 not to fill the corners of depressions 24 resulting in deformed patterns 14a. Likewise, the portions of the periphery of roller 20 defining depressions 24 are of larger size and area and are less prone to damage as a result of operation. Although interconnections 14b and 25 in the preferred form shown extend between all patterns 14a in a single row 22, it can be appreciated that interconnections 14b and 25 can be arranged in alternate manners according to the teachings of the present invention. As examples, pairs of depressions 24 in the same row 22 or adjacent rows 22 could include interconnections 25, interconnections 25 could extend in a zigzag pattern between adjacent rows, or the like. In this regard, interconnections 14b can be arranged to enhance the play value in removing patterns 14a from support material 16 according to the teachings of the present invention.

After strip sheeter 12, the sheet of support material 16 having rows of patterns 14a of food 14 thereon could be passed through a cooling tunnel 58 if desired and depending upon operational conditions and environments. Cooling tunnel 58 is provided with forced chilled air typically cooled to an air temperature in the range of 32°-40° F. (0°-4° C.) and support material 16 and food 14 remain in cooling tunnel 58 a sufficient time to cool from approximately 170° F. (77° C.) to 100° F. (38° C.). Support material 16 can be supported within cooling tunnel 58 on a stationary platform or on a moving platform such as a conveyor. In other variations, the conveyor can be extended to allow for ambient cooling to reduce the need for active cooling.

After cooling tunnel 58, support material 16 and food 14 is advanced in apparatus 10 on a platform or conveyor to a first cutting section 62. Support material 16 is perforated in the first cutting section 62 in the spacing between the rows of patterns 14a of food 14 located thereon to form longitudinally extending perforations 62a and 62b in support material 16. It should be noted that perforating occurs only through support material 16 and specifically cutting food 14 does not occur. In the most preferred form, the cutting is performed in cutting section 62 by and the apparatus of cutting section 62 essentially comprises two spaced, rotary knives arranged parallel to each other and transverse to the direction of travel of support material 16 moving past the knives. In the preferred form, apparatus 10 is equipped with a sensor to pick up one edge of the strip of support material 16 to transversely move the direction of travel of support material 16 to maintain perforating in the spacing between the rows of patterns 14a of food 14. In other variations, perforations can be provided by laser scoring apparatus.

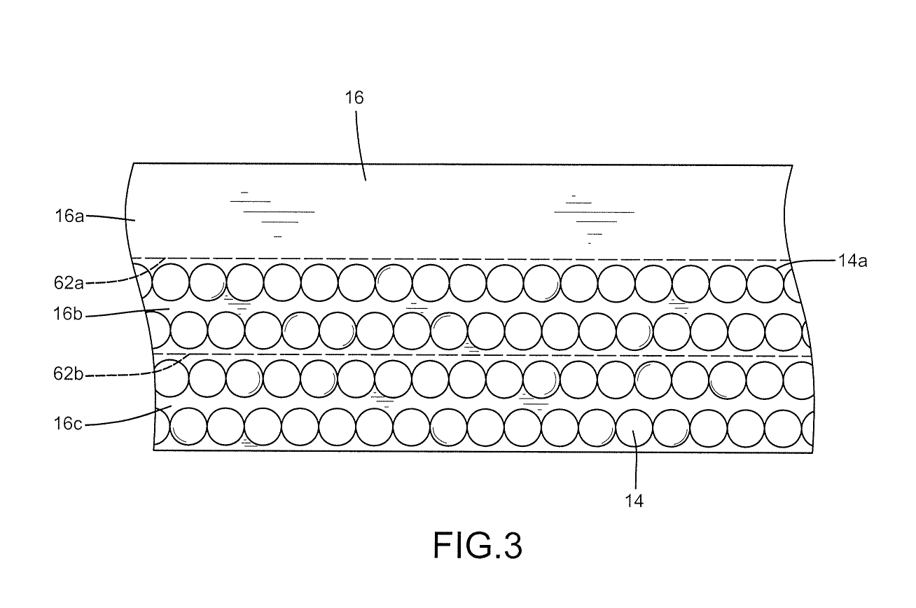

In the most preferred form, perforations 62a and 62b divide support material 16 into three longitudinally extending strips 16a, 16b and 16c as best seen in FIG. 3. In particular, strip 16a defined between a free edge of support material 16 and perforation 62a is devoid or free of food 14. Strip 16b is defined between perforations 62a and 62b and includes a first lane having one or more rows of patterns 14a of food 14, with two rows extending in the longitudinal direction being shown. Strip 16c is defined between perforation 62b and the opposite free edge of support material 16 and includes a second lane having one or more rows of patterns 14a of food 14, with two rows extending in the longitudinal direction being shown spaced in a lateral direction from the first lane of food 14 on strip 16b. It can be appreciated that although the number of rows of equally sized and shaped patterns 14a are shown in the preferred form located on strips 16b and 16c, the number of rows and/or the shape and size of patterns 14a in strips 16b and 16c can be varied according to the teachings of the present invention. In the preferred form shown, the free edges of support material 16 are in a spaced, parallel relation to each other and to perforations 62a and 62b.

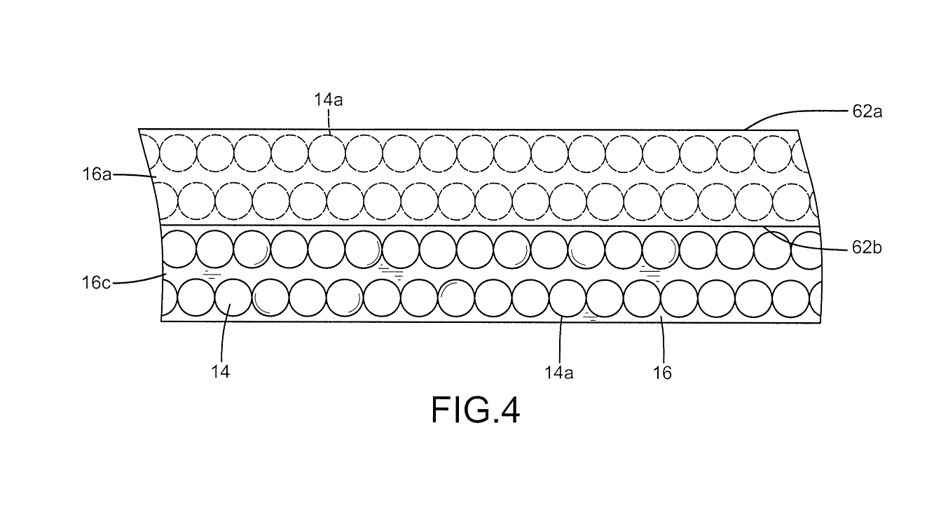

Downstream of cutting section 62, food 14 and support material 16 are passed into a folding device or area 120. Initially, strip 16a is folded to extend over strip 16b and food 14 located thereon, with the food surface of strip 16a abutting with food 14 on strip 16b, and the free surface of strip 16a now located in an uppermost position as shown in FIG. 4. It should be appreciated that perforations 62a create a fold line between strips 16a and 16b and assist folding of strip 16a relative to strip 16b in a longitudinally linear manner. In the most preferred form, folding of strip 16a relative to strip 16b is accomplished by engaging strip 16a with a rail for directing strip 16a as support material 16 is being conveyed through folding area 120.

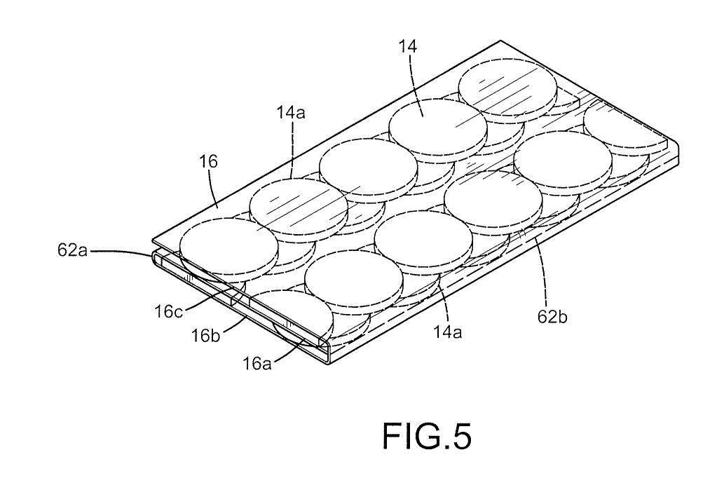

After folding of strip 16a, strip 16c is folded to extend over strip 16a extending over strip 16b, with food 14 located on strip 16c abutting with the free surface of strip 16a with the free surface of strip 16c now located in an uppermost position as shown in FIG. 5. It should be appreciated that perforations 62b create a fold line between strips 16b and 16c and assist folding of strip 16c relative to strip 16b in a longitudinally linear manner. In the most preferred form, folding of strip 16c relative to strip 16b is accomplished by engaging strip 16c with a rail for directing strip 16c as support material 16 is being conveyed through folding area 120.

Ensuring that strips 16a and 16c are folded in a longitudinally linear manner can be accomplished in other manners than perforations 62a and/or 62b according to the teachings of the present invention. As an example, instead of perforating, cutting section 62 could alter support material 16 such as by forming longitudinally extending crease depressions or similar fold lines in support material 16. In less preferred forms, perforations 62a and 62b or similar fold lines are formed in support material 16 before its introduction into strip sheeter 12 including but not limited to offsite of apparatus 10. Furthermore, depending upon the type of folding area 120 utilized, it may also be possible to consistently fold strips 16a and 16c relative to strip 16b without altering support material 16.

After folding area 120, food 14 and support material 16 are cut to lengths in a second cutting section 64. In the most preferred form, the cutting is performed in cutting section 64 by a rotary knife having a plurality of laterally extending but circumferentially spaced blades. Strips 16a-16c of food 14 and support material 16 are cut generally perpendicular to the side edges of and generally straight across strips 16a-16c of food 14 and support material 16. In cutting section 64, strips 16a-16c of food 14 and support material 16 are cut to a finite length which in the preferred form is generally equal to 6 inches (15 cm), with each food item having a leading end and a trailing end.

After cutting section 64, the food items are further processed for distribution, sale, and consumption such as being packaged in a packaging area 122 such as into a high moisture barrier container, for example, being disposed within a food package or pouch fabricated from a flexible packaging film fabricated employing a horizontal seal pouch apparatus (not shown).

It should be appreciated that the food item fabricated in apparatus 10 utilizing the methods according to the preferred teachings of the present invention results in several advantages over prior fruit snack production. Specifically, as folding can be accomplished online without stopping of conveyance of support material 16 as was required when the food item was rolled as taught by U.S. Pat. No. 5,205,106, faster line speeds and rates of production can be accomplished. More importantly, the play value of the food item is enhanced according to the teachings of the present invention. First, a folded food product presents a novel format from prior fruit snacks. Furthermore, activity is required for the consumer to unfold the food item in order to expose patterns 14a of food 14 of an unknown type. Additionally, once exposed in one preferred form, the consumer is able to select one pattern 14a from an array of patterns 14a and specifically is not required to consume food 14 in a linear arrangement as when the food item is rolled. The play value of selection can be enhanced by utilizing different colors and/or flavors between rows of patterns 14a of food 14 and/or by utilizing different shapes and sizes of patterns 14a in different or the same rows. In alternate forms, although interconnections 14b provide removal of patterns 14a in a serial manner, removal can be in a linear manner in the form shown but can also be in nonlinear manners according to the arrangements of interconnections 14b for enhancing the play value resulting from removal. Furthermore, patterns 14a have much more definition and can have distinct shapes than possible with extruded products and than even produced with molded products such as U.S. Pat. Nos. 5,205,106 ad 5,846,588 where food was removed from roller depressions by stretching a continuous layer of nonfood material within the depressions.

Continuing along apparatus 10 at one or more locations downstream of strip sheeter 12, food 14 and support material 16 are passed onto a powered or driven vacuum platen or conveyor. It can then be appreciated that the vacuum conveyor places a vacuum force on support material 16 to thereby grip support material 16. It can then be appreciated that the vacuum conveyor places the pulling or tension force on support material 16 for pulling support material 16 downstream from strip sheeter 12, for pulling support material 16 through cooling tunnel 58, first and second cutting sections 62 and 64, and/or folding area 120. Further, it can be appreciated that due to the vacuum force applied by the vacuum conveyor, positive control of support material 16 and food 14 located thereon is obtained.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method comprising:
feeding a continuous sheet of support material and food deposited on a food surface thereof in a longitudinal direction, with the continuous sheet of support material including first and second free edges extending in the longitudinal direction, with the food being deposited in first and second lanes extending in the longitudinal direction and spaced in a lateral direction perpendicular to the longitudinal direction to define a longitudinal spacing;
folding the continuous sheet of support material along a first fold line extending in the longitudinal direction, with the continuous sheet of support material between the first free edge and the first fold line defining a first strip, with the first strip extending over the food in the first lane, with the first lane located intermediate the first fold line and the second lane;
after folding along the first fold line, folding the continuous sheet of support material along a second fold line extending in the longitudinal direction parallel to the first fold line, with the continuous sheet of support material between the first and second fold lines defining a second strip including the first lane of food, with the continuous sheet of support material between the second fold line and the second free edge defining a third strip including the second lane of food, with the third strip extending over the first strip; and
after folding along the second fold line, cutting the continuous sheet of support material and food deposited thereon into finite lengths to define a food item for consumption.

2. The method of claim 1 further comprising altering the continuous sheet of support material prior to folding the continuous sheet to define the first and second fold lines to ensure folding in a linear manner.

3. The method of claim 2 with feeding the continuous sheet comprising feeding the continuous sheet of support material with the food deposited in first and second lanes each comprising at least one row of individual patterns, with the at least one row extending in the longitudinal direction.

4. The method of claim 3 with feeding the continuous sheet comprising pulling the continuous sheet of support material through an abutment nip defined between outer peripheries of first and second counter rotating rollers, with the second roller including depressions for forming the first and second lanes of food.

5. The method of claim 4 with pulling the continuous sheet of support material comprising pulling the continuous sheet of support material and food through the abutment nip with the continuous sheet of support material being intermediate the first roller and the food, with the continuous sheet of support material and food deposited thereon extending tangentially from the second roller, with the outer periphery of the first roller being smooth.

6. The method of claim 5 with pulling the continuous sheet of support material comprising pulling the continuous sheet of support material and food through the abutment nip with the first roller being heated to enhance removal of the food from the depressions of the second roller.

7. The method of claim 6 with pulling the continuous sheet of support material comprising pulling the continuous sheet of support material and food through the abutment nip with the outer peripheries of the first and second rollers having equal diameters.

8. The method of claim 5 with pulling the continuous sheet of support material comprising pulling the continuous sheet of support material and food through the abutment nip with the outer periphery of the second roller and the depressions being formed of material to which the food has less tendency to stick to than the support material when exiting the abutment nip.

9. The method of claim 8 with pulling the continuous sheet of support material comprising pulling the continuous sheet of support material and food through the abutment nip with the outer periphery of the second roller and the depressions being coated with a nonstick coating.

10. The method of claim 5 further comprising adding a layer of an edible, liquid release agent to the outer periphery of the second roller prior to the abutment nip.

11. The method of claim 10 with adding the layer comprising spraying the outer periphery of the second roller with the edible, liquid release agent before the abutment nip.

12. The method of claim 5 with pulling the continuous sheet of support material comprising pulling the continuous sheet of support material and food through the abutment nip with the depressions of the second roller including annular boundaries perpendicular to the outer periphery and arranged to create tensional removal enhancement from the depressions of the second roller.

13. The method of claim 12 with pulling the continuous sheet of support material comprising pulling the continuous sheet of support material and food in the form of sweetened intermediate moisture shelf stable fruit.

14. The method of claim 5 with pulling the continuous sheet of support material comprising pulling the continuous sheet of support material and food through the abutment nip with the depressions of the second roller being of identical size and shape.

15. The method of claim 5 with pulling the continuous sheet of support material comprising pulling the continuous sheet of support material and food through the abutment nip with each of the first and second lanes comprising two rows of individual patterns.

16. The method of claim 2 with cutting the continuous sheet of support material comprising rotating a rotary knife having at least one laterally extending blade to engage the continuous sheet of support material and food deposited thereon.

17. The method of claim 2 with altering the continuous sheet of support material comprising rotating disc cutters to perforate the continuous sheet of support material to define the first and second fold lines.

18. Food item comprising, in combination: a support material having first and second free edges and first and second fold lines extending in a spaced, parallel longitudinal direction, with a first strip being defined between the first free edge and the first fold line, a second strip being defined between the first and second fold lines, and a third strip being defined between the second free edge and the second fold line; a first lane of food extending in the second strip; and a third lane of food extending in the third strip, with the first strip folded along the first fold line and abutting with the first lane of food, with the third strip folded along the second fold line with the second lane of food abutting with the first strip, with the first strip located intermediate the first and second lanes of food.

19. The food item of claim 18 wherein the first and second fold lines are perforations.

20. The food item of claim 19 wherein the first free edge is spaced from and parallel to the second free edge and to the first and second fold lines, with the food being sweetened intermediate moisture shelf stable fruit, and with the first and second lanes of food each comprising at least one row of discrete individual patterns extending in the longitudinal direction.

21. Apparatus for fabricating a food item comprising, in combination:
a strip sheeter depositing food upon a continuous sheet of support material including first and second free edges extending in the longitudinal direction, with the food being deposited in first and second lanes extending in the longitudinal direction and spaced in a lateral direction perpendicular to the longitudinal direction to define a longitudinal spacing;
a folding device folding the continuous sheet of support material along a first fold line extending in the longitudinal direction, with the continuous sheet of support material between the first free edge and the first fold line defining a first strip, with the first strip extending over the food in the first lane, with the first lane located intermediate the first fold line and the second lane, with the folding device also folding the continuous sheet of support material along a second fold line extending in the longitudinal direction parallel to the first fold line, with the continuous sheet of support material between the first and second fold lines defining a second strip including the first lane of food, with the continuous sheet of support material between the second fold line and the second free edge defining a third strip including the second lane of food, with the third strip extending over the first strip; and
a cutting device cutting the continuous sheet of support material and food deposited thereon into finite lengths to define a food item for consumption.

22. The apparatus of claim 21 further comprising, in combination:
a cutting device perforating the continuous sheet of support material to define the first and second fold lines.
